(19) United States
(12) Patent Application Publication
(10) Pub. No.: US 2007/0169879 A1
(43) Pub. Date: Jul. 26, 2007

(54) Method and apparatus for producing a detail

(76) Inventor: Lars-Goran Hakansson, Malmo (SE)

Correspondence Address: STITES & HARBISON PLLC, 1199 NORTH FAIRFAX STREET, SUITE 900, ALEXANDRIA, VA, 22314, US

(21) Appl. No.: 10/580,229

(22) PCT Filed: Nov. 19, 2004
(86) PCT No.: PCT/IB04/52942

§ 371 Date: Feb. 16, 2007

(30) Foreign Application Priority Data
Nov. 21, 2003 (SE) 0303127-5

(51) Int. Cl. B32B 37/00; B32B 38/16; B32B 38/00; B32B 38/12

(52) U.S. Cl. 156/221; 156/281; 156/250; 156/252; 156/535

(57) ABSTRACT

The present invention relates to a method of producing a generally flat, planar detail, such as an electronic product or a component of such, of a plastically formable material, characterised in that it comprises the steps of first applying an adhesive cover layer containing colour pigment and a circuit comprising electrical and/or optical conductors, on at least one of the surfaces of the detail, and the form the detail plastically in order to obtain its end form. The invention also relates to a cover layer to be used in the method and a detail with the cover layer produced according to the method.

### TECHNICAL AREA

The present invention relates to a method for producing a detail, and more specifically a detail arranged with a layer.

### BACKGROUND OF THE INVENTION

Many apparatuses and components, such as for example apparatus cabinets, operating panels, the front part of stereos, satellite receivers, video and DVD apparatuses and the like has a affront or a panel containing a number of components such as buttons, displays, LED's and the like and are coated with requested colour and indicia and other indications.

The conventional way of producing this type of front or panel us to start with a sheet material of metal. The sheet is cut or stamped to the desired dimensions and worked on for assembly of the desired components for connection to a chassis, a cover or the like. The machining may consist of drilling or stamping operations for producing holes in the sheet, bending, buckling and/or folding of the sheet in order to obtain folds, changes of the profile and desired appearance of the panel.

After this the sheet is washed clean for subsequent coating to the desired colour and structure, often by powder coating and subsequent curing in a hardening furnace in order to obtain a wear resistant and appearance pleasing layer. If it is desired that certain surfaces shall not obtain a coating layer, these have to be masked first. Thereafter the desired information and indicia are screen printed on the coated surface.

The above mentioned method comprises a relatively large number of manufacturing steps, where certain, such as the masking and eventually the screen printing steps are done manually, which increases the cost of the production. If the detail also contains curved surfaces the screen printing may be more complicated.

Another area of production of details are such with complex form, which anyway shall have an appealing appearance and that often are arranged with functions such as button, displays and the like, such as mobile telephones, remote controls, electronic notebooks and the like devices. There is often a desire from the users to be able to change the appearance on the apparatuses in order to have a personal touch on these. The casings or shells of many of these apparatuses are manufactured from plastic, often injection moulded. Thereafter the casings are taken to a coating station in order to receive the desired appearance, which coating in many cases has to be done in several steps if many colours and/or complicated patterns shall be applied.

In order to facilitate the production of in particular details of metal sheet, a method has been developed, which is described in the Swedish patent application no. SE 0102907-3, with the same applicant as for the present application.

According to this method a sheet of metal material is washed and arranged with a layer of adhesive material, which layer contains the desired colour that the detail is to have as well as the signs and indicia that are desired. Thereafter the machining is done in order to obtain the desired shape and size as well as cut-outs and holes in the detail.

This method means that the coating and screen printing steps, as well as eventually the masking, might completely be omitted, which greatly facilitates and reduces the cost of production, which also may be done completely automatically.

For injection moulded plastic details, a few different methods have been developed, such as IMD, In Mould Decoration, and IML, In Mould Labelling, which in short function such that for IMD to feed a continuous strip containing the desired pattern or surface layer between the mould halves. When these are closed and the plastic is pushed into the mould cavity the label is pressed against the mould wall at the same time as it is attached to the plastic. For IML a partly pre-formed “label” or surface layer is put in one of the mould halves, after which the plastic is injected. For the cases where cut-outs and the like are to be formed in the casing, the surface layer has to be removed in these places, which entails a further production step.

The products of today put increasing demands on simplified and cheaper manufacturing at the same time as there is a desire to integrate more and more functions in the finished apparatuses as well as increasing demands are put from the users regarding the appearance of the products and the possibilities of making them more “personal” by exchanging casing parts.

Regarding components on this type of panels, fronts and casings, such as buttons, switches, lamps, displays and the like, thee are usually mounted in cut-outs and holes arranged in the panel. This may partly be done automatically but for certain components, the mounting has to be done automatically. Further, of course holes and cut-outs have to be done in the sheet in order to mount these. This adds to maintaining rather high productions costs, even if the described method according to SE 0102907-3 is used.

### BRIEF DESCRIPTION OF THE INVENTION

According to a main aspect of the invention, its aim is to provide a method and a device for simplifying the production of the above mentioned type of detail at the same time as it increases the possibilities of integrating components and functions.

This aim is solved by an invention characterised be the independent claims 1 and 6. Further aspects of the invention are obtained by the dependent claims.

According to a main aspect of the invention, it is characterised by a method for finishing of a generally planar, flat detail of a plastically deformable material, characterised in that it comprises the steps of applying an adhesive cover layer comprising colour pigments on at least one of the surfaces of the detail as well as electrical conductors and to machine the detail mechanically so that it obtains its end form.

The advantages with the present invention are several. One aspect is that the production of this type of details and components are simplified in that several production steps are completely omitted and that several “intelligent” functions are built in the detail. It thus becomes more complete in a few steps that ever have been able to be produced earlier. With the method according to the invention it also becomes much easier to change the appearance and structure on the detail because it is much simpler to produce a label or sticker with the desired appearance and structure than what is possible with conventional coating.

Because a number of functions are built into the label itself, which then is put on a carrier of a suitable type which is machinable, for instance remote controls and mobile telephones may be produced in a very cost-effective and simplified manner. This is in particular true when most of the electric and electronic components nowadays are so small and energy effective that they may be put in a label according to the invention without this becoming too voluminous. This in turn produces possibilities for mass production of simple electronic apparatuses such as for example mobile telephones where the label contains all the electronics and equipment that is required for making phone calls. In this aspect the telephones may be pre-programmed for a certain number of minutes of phoning and that the battery capacity is adapted to this. When the telephone is used, it may be discarded or reloaded. Thereby this type of telephone replaces existing cash phone cards; i.e. they will function as disposable telephones in generally the same manner as the disposable cameras.

Production-wise a suitable carrier may be rolled from a band, passed a station where the intelligent labels, arranged with necessary circuits and components, are applied, and then be passed to a machining station where the end form is obtained.

In all much fewer steps for producing details of this type are obtained than now may be obtained. Further, the labels provide great possibilities of designing the surface layer in many ways and with unlimited design regarding colours, signs, symbols, structure and the like, all for appealing to the potential customers and/or suppliers of such details.

These and other aspects of and advantages with the present invention will become apparent from the detailed description of the invention and from the appended drawings.

### DETAILED DESCRIPTION OF THE DRAWINGS

In the following description of the invention, reference will be made to the appended drawings, of which,

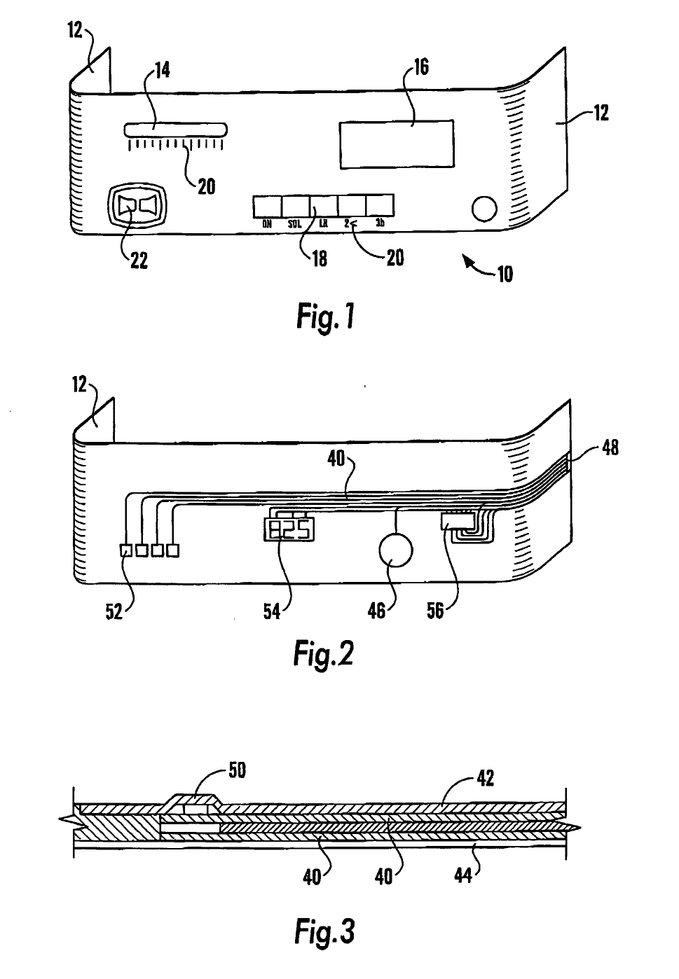

FIG. 1 shows an example of a detail that can be produced with the present invention,

FIG. 2 shows the detail according to FIG. 1 with the new aspects of the present invention,

FIG. 3 shows a part view in cross-section of a cover layer according to the invention,

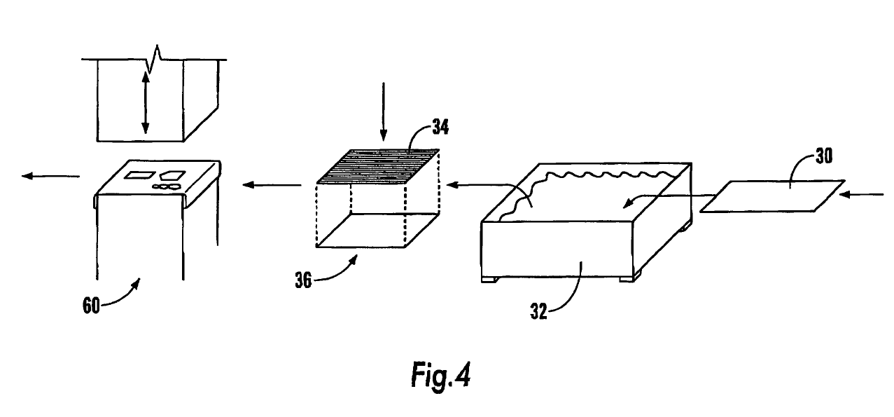

FIG. 4 shows schematically the work cycle for producing the detail, and

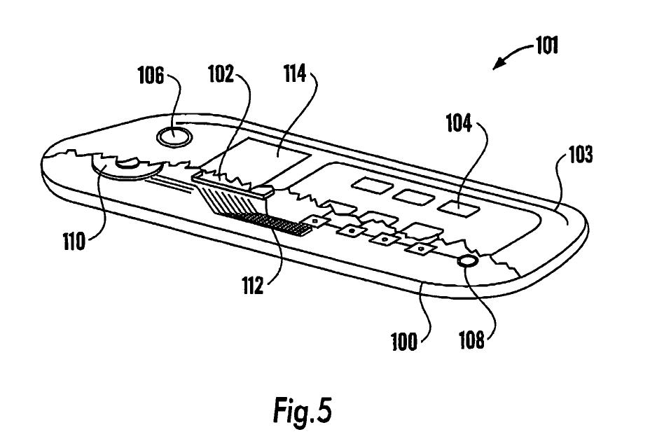

FIG. 5 shows an example of a detail produced according to the invention.

### DETAILED DESCRIPTION OF THE INVENTION

According to the invention such a detail is produced according to the following. Sheet material 30 of for example metal, but also from other mechanically formable and/or machinable materials, are taken from a storage where they either can be stored in the right dimensions or as band that is cut to appropriate lengthy.

If so required, the surfaces of the sheets are cleaned 32 by degreasing of the like treatment. The sheet is fixated in position, after which a cover layer 34 is applied to at least one surface of the detail, in the example shown the front side 36, FIG. 2

The cover layer comprises a self-adhesive label with generally the same size as the front side of the detail. It is also conceivable that the self-adhesive layer is placed between the cover layer and the sheet. The cover layer has a suitable colour that for example corresponds to the rest of the casing to which the detail is a component, and information, such as text, logotype and the like, in a contrasting colour for readability. The cover layer can also have a suitable structure depending on desire and taste, such as relief, friction enhancing material and structure etc. The texts are placed so that they correspond to the cut-outs, slots, holes and the like 14, 16, 18 that are to be done in the detail, FIG. 1.

The cover layer is further arranged with a number of circuits, 40, FIG. 2, which in their most simple case constitute electrical or optical conductors capable of conducting electricity and light respectively. These are embedded in one or more layers between the coloured surface layer 42 and the self-adhesive layer 44, FIG. 3. In the shown embodiment with electrical conductors, these may be designed as a flat cable type in order to obtain a common connection point for a connection block. The electrical conductors may then be drawn such in the layer that the ends of certain conductors are placed adjacent the place where the subsequent machining is to take place, such as for example stamping of a hole for an electric component such as a switch or a lamp. During the subsequent machining the electrical conductors are released such that the electrical component conductively can be connected to the conductors. In this aspect the component may be designed such that contact members cut through the surface layer and comes in contact with the conductors, such as is done for a contact member for flat cables. Such a contact member 48 can also be used for the connection of the electrical wires with the rest of the equipment in the apparatus that the panel is to be mounted on. It is also conceivable that the electrical conductors are arranged around the periphery of the hole to be machined 46, whereby it is possible at the edge of the hole to pull out the electrical conductors for soldering them to the electric component.

It is further possible that the circuit in the cover layer is arranged with further electrical or optical components embedded in this, such as touch buttons 50, LED-diodes 52 and thin LCD and optical displays 54, light conductors, for naming a few components, which are connected to the electrical conductors. It is also possible to arrange memory units, micro processors 56, passive and active components, audio components, energy sources, antennas and the like in the cover layer for further integrating components and functions in the cover layer.

Depending on the thickness of the components and the conductors, the thickness of the surrounding layers is adapted such that the cover layer obtains a planar appearance when attached to the carrier. The electrical conductors and the components are placed such on the carrier that machining is not made more difficult and that stiff components such a micro processors are not placed on surfaces that shall be bent or curved during the subsequent treatment.

During attachment of the cover layer this is in register with the sheet, which is done in a manner known in the technical area. For example the cover layer may be wound on a roll, with a protective layer that protects the adhesive under side, which protective layer is peeled off during the application of the label.

The now surface treated detail is then fed to a machining station 60. In the example shown with the front panel, this entails bending of the end pieces and stamping of the openings and the slit. The attached label preferably has a certain elasticity that permits bending of the sheet and thus the cover layer without ripping it or pulling it apart. In this context, the conductors of the circuit may be done in a material that permits a certain flexibility and elongation without breaking them during machining. The cut-outs and the slits are stamped and/or drilled in the sheet at suitable positions corresponding to the information on the cover layer. In this context it is to be understood that the mechanical machining can be done in one or several subsequent steps depending on which operations that are to be done.

After the mechanical machining the detail is now ready for mounting and thus requires no further treatment. Regarding mechanical machining, it is to be understood that it comprises a number of different operations that are common when producing details, such as drilling, broaching, pulling, bending in order to form three-dimensional surfaces and the like. Regarding forming of three-dimensional surfaces, the material of the cover layer is preferably such that it admits a certain stretching without forming folds or ruptures. If the information is to be arranged in the part of the label that is bent three-dimensionally, this may be taken into consideration already during production of the label, to that the information, for example in the form of text, obtains the right appearance during bending. In connection to this it is to be mentioned that the label is not required to cover the whole surface of the detail. For example, the label can be formed such that certain parts are left free, for example in order to admit metallic contact between the detail and components that are attached to the detail, for example ground.

For very complicated forms that are obtained by form pressing, it is conceivable that the cover layer of the label is preformed in order to at least mainly correspond to the end form of the detail. In this manner, the label material does not need to be exposed to so large elongation during the actual forming of the detail.

During production of details according to the invention, several different techniques can be used, which are known within the technical area for obtaining a rational handling and process. As mentioned the starting material can be wound on a roll that is cut in suitable lengths, the starting material can be stamped out from a larger sheet, they can be cut to the right size after the application of the cover layer and the like. The same is true for the adhesive cover layer that, as mentioned, can be wound on a roll, be separate labels that are applied with gripping and pressing means with vacuum technology, different guide arrangements in order to have the sheet or the carrier in register with the label and the like.

The labels can as described contain a number of different components and functions that are “integrated” in these in order to obtain a complete as possible product. In the above, it has been mentioned positions of labels on fronts and/or outer surfaces of details but of course the invention functions in the same appropriate way inside apparatuses, for example on both sides of a front; within a housing and the like. The clear advantage is that many apparatuses may be done much smaller and slimmed than with conventional techniques.

An example if this is shown in FIG. 4, showing a mobile telephone comprising a carrier 100 and a label 101. This contains a processors 102 for handling the normal functions of a mobile phone, such as to send and receive calls, antenna 103, keypad 104 to dial numbers, speaker 106, microphone 108 and some form of energy source 110, for example a battery cell, but also solar cells may be feasible for certain applications. It can further comprise memory units 112 for storing telephone numbers as well as simple displays 114 for displaying dialed numbers and incoming numbers. In connection to the shown example it is to be understood that the carrier for certain components may be pre-formed with cavities and indentations in order to house these and in order to obtain the desired appearance of the product.

In this context it is also conceivable to have remote controls for different apparatuses that are built in corresponding manner and with components integrated in order to obtain the desired function of the control.

As mentioned the present invention offers unlimited possibilities of producing details in a cost-effective way with a very specialized design and appearance.

In all large savings are obtained regarding work steps and production equipment compared to conventional technology.

1. Method of producing a generally flat, planar detail, such as an electronic product or a component of such, of a plastically formable material, characterized in that it comprises the steps:
first applying an adhesive cover layer containing color pigment and a circuit comprising electrical and/or optical conductors, on at least one of the surfaces of the detail, and
forming the detail plastically in order to obtain its end form.

2. Method according to claim 1, characterized in that the cover layer is a colored cover layer.

3. Method according to claim 1, characterized in that the cover layer is arranged with signs and symbols.

4. Method according to claim 1, characterized in that the plastic forming comprises stamping, drawing, bending, drilling, or broaching.

5. Method according to claim 1, characterized in the further step of cleaning the detail before the application of the cover layer.

6. Device for producing a generally flat, planar detail, such as an electronic product or a component of such, of a plastically formable material, characterized in that it comprises:
means for first applying an adhesive cover layer containing color pigment and a circuit comprising electrical and/or optical conductors, on at least one of the surfaces of the detail, and
means for subsequent forming of the detail plastically in order to obtain its end form.

7. Device according to claim 6, characterized in that it comprises means for cleaning the detail before the application of the cover layer.

8. Cover layer to be used in the method according to claim 1, characterized in that it comprises at least one circuit.

9. Cover layer according to claim 8, characterized in that the circuit comprises functional components.

10. Cover layer according to claim 9, characterized in that the functional components are electrical or optical.

11. Cover layer according to claim 9, characterized in that the components comprise processors, memory units, light means, audio means, active and passive components, displays, keypads and the like.

12. Detail produced of a cover layer according to claim 8 and by the method of producing a generally flat, planar detail, such as an electronic product or a component of such, of a plastically formable material, characterized in that it comprises the steps of first applying an adhesive cover layer containing color pigment and a circuit comprising electrical and/or optical conductors, on at least one of the surfaces of the detail, and then forming the detail plastically in order to obtain its end form.
